(19) United States
(12) Patent Application Publication
(10) Pub. No.: US 2023/0412224 A1
(43) Pub. Date: Dec. 21, 2023

(54) CSI Reporting on Protocol Layer 2

(71) Applicant: Telefonaktiebolaget LM Ericsson (PUBL), Stockholm (SE)

(72) Inventors: Weidong Kong, Bromma (SE); Magnus Finne, SUNDBYBERG (SE); Dejan Miljkovic, Solna (SE); Liheng Liu, HELSINGBORG (SE); Yang Zhang, SOLLENTUNA (SE); Walter Müller, UPPLANDS VÄSBY (SE)

(21) Appl. No.: 18/034,598

(22) PCT Filed: Oct. 30, 2020
(86) PCT No.: PCT/SE2020/051054

§ 371 Date: Apr. 28, 2023

(51) Int. Cl. H04B 7/06; H04B 17/318

(52) U.S. Cl. CPC H04B 7/0626; H04B 17/328

(57) ABSTRACT

There is provided mechanisms for CSI reporting on protocol layer 2. A method is performed by a wireless device. The wireless device is served by an access network node on a serving beam. The wireless device is configured with event conditions as to when to provide the CSI reporting to the access network node and with reporting configuration as to how to provide the CSI reporting to the access network node. The method comprises obtaining CSI values by monitoring candidate beams in which reference signals are transmitted by the access network node. The method comprises determining, based on comparing the CSI values to the event conditions, that at least one of the event conditions for CSI reporting is fulfilled. The method comprises sending the CSI reporting to the access network node as a protocol layer 2 CSI report and in accordance with the reporting configuration.

### TECHNICAL FIELD

Embodiments presented herein relate to a method, a wireless device, a computer program, and a computer program product for channel state information (CSI) reporting on protocol layer 2. Embodiments presented herein further relate to a method, an access network node, a computer program, and a computer program product for receiving the CSI reporting on protocol layer 2.

### BACKGROUND

In wireless communication systems, the transmission conditions change over time and space. Therefore, for a (radio) access network node, such as a base station (BS), to properly schedule the transmission of data to a wireless device, such as a user equipment (UE), using appropriate modulation and code rates, the wireless device regularly reports channel conditions to the access network node. In wireless communication systems like Long Term Evolution (LTE) and beyond, the access network node determines the used transport format, transport block size, modulation and coding scheme (MCS), multiple-input multiple output (MIMO) transmission mode, etc. for both downlink (DL) and uplink (UL). To be able to perform this determination for the DL, the access network node requires information from the wireless device regarding properties of the current DL channel, commonly referred to as Channel State Information (CSI). CSI reporting is performed on protocol layer 1. In some examples, the reported CSI consist of Channel Quality Information (CQI), Precoder Matrix Index (PMI), and Rank Indicator (RI). In one approach to sending CSI reports, the wireless device sends regular Channel Quality Indicator (CQI) reports. The CQI is an index value that efficiently quantizes measured signal quality at the wireless device. Also other forms of CSI may be possible, such as explicit channel quantization, effective channel quantization including receiver processing, noise plus interference feedback as well as receive covariance feedback. To enable such measurement reports, the wireless device measures on DL Reference Signals (RS). The used RS might be cell-specific and transmitted frequently.

There may be many wireless devices served by the same access network node at the same time, and all wireless devices need to send CSI reports. Further, each wireless device may have multiple CSI values to report. For example, CSI reporting for an Orthogonal Frequency Division Multiplex (OFDM) downlink signal may require wireless devices to report wideband CSI values, along with one or more narrowband CSI values that are restricted to particular frequency sub-bands of interest.

In order to limit the number of CSI reports that are sent, the wireless devices might be configured for aperiodic CSI reporting. However, there might still be scenarios where current techniques for CSI reporting are not suitable or sufficient. An illustrative example of on such scenario is in wireless communication systems where each access network node communicates with its served wireless devices via transmission and reception points (TRPs), where the CSI reporting might be outdated when it reaches the access network node.

Hence, there is still a need for more time-efficient CSI reporting.

### SUMMARY

An object of embodiments herein is to provide efficient CSI reporting.

According to a first aspect there is presented a method for CSI reporting on protocol layer 2. The method is performed by a wireless device. The wireless device is served by an access network node on a serving beam. The wireless device is configured with event conditions as to when to provide the CSI reporting to the access network node and with reporting configuration as to how to provide the CSI reporting to the access network node. The method comprises obtaining CSI values by monitoring candidate beams in which reference signals are transmitted by the access network node. The method comprises determining, based on comparing the CSI values to the event conditions, that at least one of the event conditions for CSI reporting is fulfilled. The method comprises sending the CSI reporting to the access network node as a protocol layer 2 CSI report and in accordance with the reporting configuration.

According to a second aspect there is presented a wireless device for CSI reporting on protocol layer 2. The wireless device is configured to be served by an access network node on a serving beam. The wireless device is configured with event conditions as to when to provide the CSI reporting to the access network node and with reporting configuration as to how to provide the CSI reporting to the access network node. The wireless device comprises processing circuitry. The processing circuitry is configured to cause the wireless device to obtain CSI values by monitoring candidate beams in which reference signals are transmitted by the access network node. The processing circuitry is configured to cause the wireless device to determine, based on comparing the CSI values to the event conditions, that at least one of the event conditions for CSI reporting is fulfilled. The processing circuitry is configured to cause the wireless device to send the CSI reporting to the access network node as a protocol layer 2 CSI report and in accordance with the reporting configuration.

According to a third aspect there is presented a wireless device for CSI reporting on protocol layer 2. The wireless device is configured to be served by an access network node on a serving beam. The wireless device is configured with event conditions as to when to provide the CSI reporting to the access network node and with reporting configuration as to how to provide the CSI reporting to the access network node. The wireless device comprises an obtain module configured to obtain CSI values by monitoring candidate beams in which reference signals are transmitted by the access network node. The wireless device comprises a determine module configured to determine, based on comparing the CSI values to the event conditions, that at least one of the event conditions for CSI reporting is fulfilled. The wireless device comprises a send module configured to send the CSI reporting to the access network node as a protocol layer 2 CSI report and in accordance with the reporting configuration.

According to a fourth aspect there is presented a computer program for CSI reporting on protocol layer 2. The computer program comprises computer program code which, when run on processing circuitry of a wireless device, causes the wireless device to perform a method according to the first aspect.

According to a fifth aspect there is presented a method for receiving CSI reporting on protocol layer 2. The method is performed by an access network node. The access network node serves a wireless device on a serving beam. The method comprises configuring the wireless device with event conditions as to when the wireless device is to provide the CSI reporting to the access network node and with reporting configuration as to how the wireless device is to provide the CSI reporting to the access network node. The method comprises transmitting reference signals in candidate beams. The method comprises receiving the CSI reporting from the wireless device as a protocol layer 2 CSI report and in accordance with the reporting configuration.

According to a sixth aspect there is presented an access network node for receiving CSI reporting on protocol layer 2. The access network node is configured to serve a wireless device on a serving beam. The access network node comprises processing circuitry. The processing circuitry is configured to cause the access network node to configure the wireless device with event conditions as to when the wireless device is to provide the CSI reporting to the access network node and with reporting configuration as to how the wireless device is to provide the CSI reporting to the access network node. The processing circuitry is configured to cause the access network node to transmit reference signals in candidate beams. The processing circuitry is configured to cause the access network node to receive the CSI reporting from the wireless device as a protocol layer 2 CSI report and in accordance with the reporting configuration.

According to a seventh aspect there is presented an access network node for receiving CSI reporting on protocol layer 2. The access network node is configured to serve a wireless device on a serving beam. The access network node comprises a configure module configured to configure the wireless device with event conditions as to when the wireless device is to provide the CSI reporting to the access network node and with reporting configuration as to how the wireless device is to provide the CSI reporting to the access network node. The access network node comprises a transmit module configured to transmit reference signals in candidate beams. The access network node comprises a receive module configured to receive the CSI reporting from the wireless device as a protocol layer 2 CSI report and in accordance with the reporting configuration.

According to an eighth aspect there is presented a computer program for receiving CSI reporting on protocol layer 2, the computer program comprising computer program code which, when run on processing circuitry of an access network node, causes the access network node to perform a method according to the fifth aspect.

According to a ninth aspect there is presented a computer program product comprising a computer program according to at least one of the fourth aspect and the eighth aspect and a computer readable storage medium on which the computer program is stored. The computer readable storage medium could be a non-transitory computer readable storage medium.

Advantageously, these aspects provide time-efficient CSI reporting.

Advantageously, according to these aspects, the CSI reporting is not outdated when it reaches the access network node.

Advantageously, the wireless device being configured with event triggered CSI reporting, beam switches and/or TRP switches are enabled to be performed more efficiently and timely by the access network node.

Advantageously, the CSI reporting for beam switch or TRP switch will only be performed when needed, which in turn enables network resources to be saved.

Advantageously, these aspects enable unnecessary CSI reporting transmission to be avoided, which in turn will enhance power savings in the wireless device.

Advantageously these aspects enable network capacity to be increased since the CSI is reported only when needed, whereas CSI reporting for mobility handling during normal conditions e.g. for a wireless device that is not moving, is not needed.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise.

The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 and FIG. 2 are schematic diagrams illustrating a wireless communication system according to embodiments;

FIGS. 3 and 4 are flowcharts of methods according to embodiments;

FIG. 5 is a signalling diagram of a method according to an embodiment;

FIG. 6 is a schematic diagram showing functional units of a wireless device according to an embodiment;

FIG. 7 is a schematic diagram showing functional modules of a wireless device according to an embodiment;

FIG. 8 is a schematic diagram showing functional units of an access network node according to an embodiment;

FIG. 9 is a schematic diagram showing functional modules of an access network node according to an embodiment; and FIG. 10 shows one example of a computer program product comprising computer readable means according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

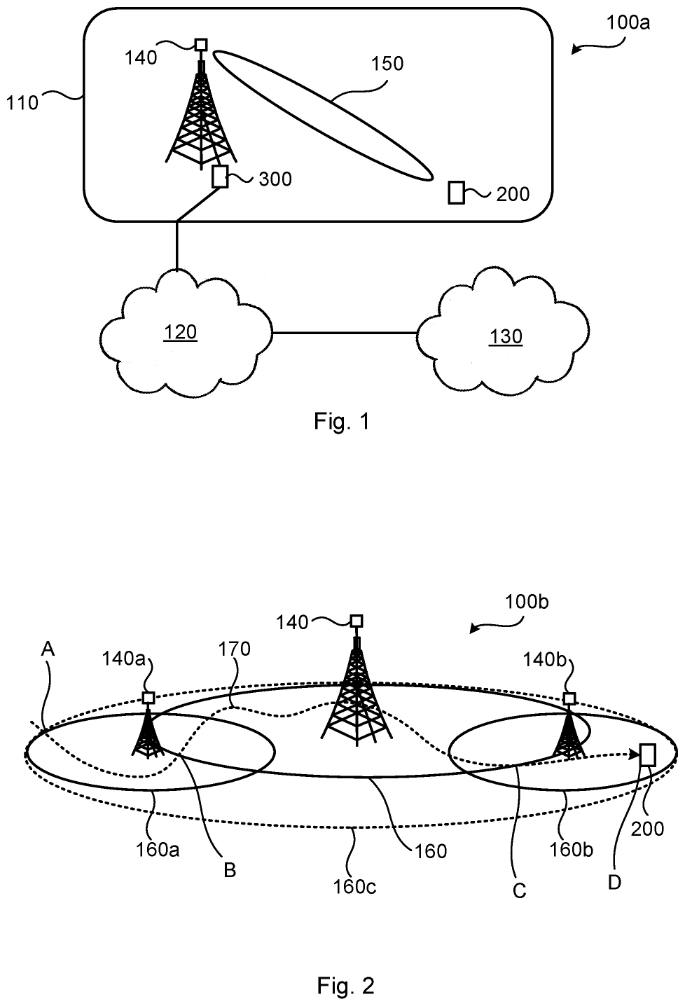

FIG. 1 is a schematic diagram illustrating a wireless communication system 100a where embodiments presented herein can be applied. The wireless communication system 100a could be a third generation (3G) telecommunications network, a fourth generation (4G) telecommunications network, a fifth generation (5G) telecommunications network, or any evolvement thereof, and support any 3GPP telecommunications standard, where applicable.

The wireless communication system 100a comprises a (radio) access network node 300 configured to provide network access to wireless devices, as represented by wireless device 200, in a (radio) access network 110. The (radio) access network 110 is operatively connected to a core network 120. The core network 120 is in turn operatively connected to a service network 130, such as the Internet. The wireless device 200 is thereby enabled to, via the access network node 300, access services of, and exchange data with, the service network 130.

Examples of access network nodes 300 are radio base stations, base transceiver stations, Node Bs, evolved Node Bs, gNBs, access points, access nodes, and integrated access and backhaul nodes. Examples of wireless devices 200 are user equipment (UE), mobile stations, mobile phones, handsets, wireless local loop phones, smartphones, laptop computers, tablet computers, network equipped sensors, network equipped vehicles, wearable communication devices, and so-called Internet of Things devices.

The access network node 300 comprises, is collocated with, is integrated with, or is in operational communications with, one or more TRPs 140. The access network node 300 (via its (one or more TRPs 140) and the wireless device 200 are configured to communicate with each other in beams, one of which is illustrated at reference numeral 150. In this respect, beams that could be used both as transmit beams and receive beams will hereinafter simply be referred to as beams.

As noted above, there is still a need for more time-efficient CSI reporting. This will be illustrative next with reference to FIG. 2 which shows a deployment example of a wireless communication system 100b where a cell 160c is served by three TRPs 140, 140a, 140b. The TRPs 140, 140a, 140b are all controlled by one and the same access network node 300 (not shown in FIG. 2) as in FIG. 1. Each TRP 140, 140a, 140b defines its own coverage region, or sub-cell, 160, 160a, 160b, within the cell 160c. Each TRP 140, 140a, 140b will transmit its own reference signals for the wireless device 200 to monitor and measure on. Additionally, or alternatively, each TRP 140, 140a, 140b is configured to transmit and receive in one or more beams, or even multiple beams, where each beam 150 has its own reference signals for the wireless device 200 to monitor and measure on (this is not shown in FIG. 2). As the multiple TRPs 140, 140a, 140b (or beams 150) belong to the same cell, a wireless device 300 moving between these TRPs 140, 140a, 140b (or beams 150) along a path 170 from point A to point D does not need to perform radio resource control (RRC) ordered handover, here called protocol layer 3 handover, when the TRPs 140, 140a, 140b belong to the same cell 160c. Instead, it is sufficient that the wireless device 200 is handed over from one TRP to another TRP in the same cell 160c, here called protocol layer 2 handover. These handovers within the cell 160c are performed at point B from TRP 140a to TRP 140 and at point C from TRP 140 to TRP 140b.

However, the wireless device 200 still needs to report CSI for the different TRPs 140, 140a, 140b (or beams 150) to help the access network node 300 to decide which TRP 140, 140a, 140b (and/or beam 150) that will be used for serving the wireless device 200. The TRP (or beam) transition occurs more frequently than the transition from cell to cell; the wireless device 200 enters cell 160c at point A but then remains within cell 160c when transitions between TRPs are performed at points B and C. Therefore, if the CSI reporting is performed on protocol layer 3, there is a risk that the CSI is outdated when the CSI report reaches the access network node 300. As a consequence thereof, the access network node 300 might issue the wrong TRP command for the wireless device 200.

The embodiments disclosed herein therefore relate to mechanisms for CSI reporting on protocol layer 2 and mechanisms for receiving CSI reporting on protocol layer 2. Another term for protocol layer 2 is radio layer 2.

Hence, the embodiments disclosed herein equally relate to mechanisms for CSI reporting on radio layer 2 and mechanisms for receiving CSI reporting on radio layer 2. In order to obtain such mechanisms there is provided a wireless device 200, a method performed by the wireless device 200, a computer program product comprising code, for example in the form of a computer program, that when run on processing circuitry of the wireless device 200, causes the wireless device 200 to perform the method. In order to obtain such mechanisms there is further provided an access network node 300, a method performed by the access network node 300, and a computer program product comprising code, for example in the form of a computer program, that when run on processing circuitry of the access network node 300, causes the access network node 300 to perform the method.

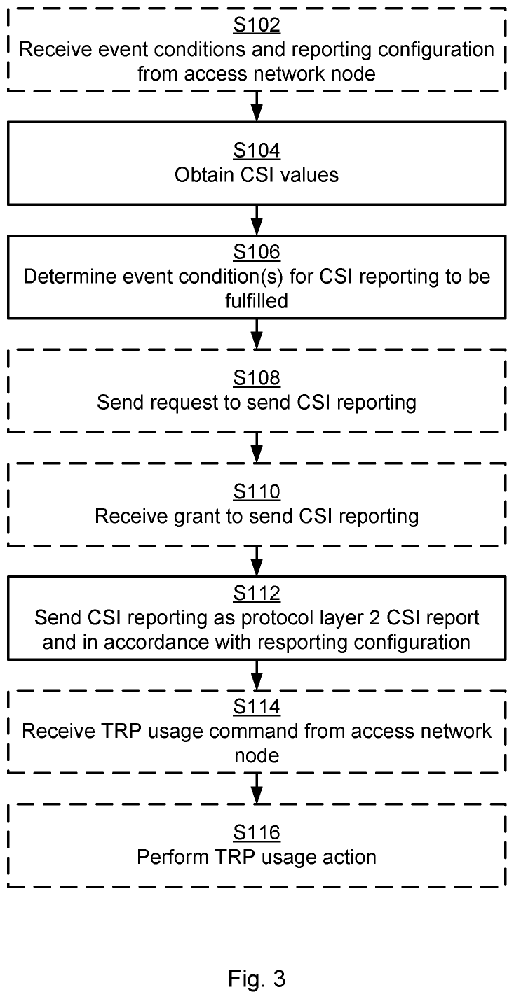

Reference is now made to FIG. 3 illustrating a method for CSI reporting on protocol layer 2 as performed by the wireless device 200 according to an embodiment. The wireless device 200 is served by an access network node 300 on a serving beam. The wireless device 200 is configured with event conditions as to when to provide the CSI reporting to the access network node 300 and with reporting configuration as to how to provide the CSI reporting to the access network node 300. This enables event-triggered layer 2 CSI reporting.

The wireless device 200 monitors candidate beams (either generated by its serving TRP 140, 140a, 140b or a neighbouring TRP 140, 140a, 140b). Hence, the wireless device 200 is configured to perform step S104.

S104: The wireless device 200 obtains CSI values by monitoring candidate beams in which reference signals are transmitted by the access network node 300.

The wireless device 200 by evaluates criteria for reporting the CSI to the access network node 300. Hence, the wireless device 200 is configured to perform step S106.

S106: The wireless device 200, based on comparing the CSI values to the event conditions, determines that at least one of the event conditions for CSI reporting is fulfilled.

After a condition for CSI reporting is fulfilled, the wireless device 200, in accordance with the reporting configuration, performs the CSI reporting. Hence, the wireless device 200 is configured to perform step S112.

S112: The wireless device 200 sends the CSI reporting to the access network node 300 as a protocol layer 2 CSI report and in accordance with the reporting configuration.

The wireless device 200 will refrain from sending any CSI reporting to the access network node 300 before any condition for the CSI reporting is fulfilled. This method introduces a new mechanism for event-based layer 2 CSI reporting, which could be used for any scenarios where CSI reporting is only needed when some conditions are fulfilled.

It is noted that although the herein disclosed embodiments are based on event-based layer 2 CSI reporting, the herein disclosed embodiments are also applicable to other types of event-based layer 2 measurement reporting other than CSI reporting.

Embodiments relating to further details of CSI reporting on protocol layer 2 as performed by the wireless device 200 will now be disclosed.

Th Hence, in some embodiments, the wireless device 200 is configured to perform (optional) step S102: S102: The wireless device 200 receives the event conditions and the reporting configuration from the access network node 300.

In other aspects the event conditions and the reporting configuration are preconfigured in the wireless device 200. That is, in other embodiments, the wireless device 200 is preconfigured to send the CSI reporting to the access network node 300. Alternatively, or in addition to these embodiments, the event conditions and the reporting configuration follow a standard.

There may be different ways for the wireless device 200 to obtain the CSI values. In some embodiments the CSI values are obtained by the wireless device 200 measuring received power on the reference signals (e.g., reference signal received power; RSRP) as received by the wireless device 200.

In some aspects, the wireless device 200, before sending the CSI reporting, requests the access network node 300 to grant the wireless device 200 resources to send the CSI reporting. In this respect, as used hereinafter, the term resource generally refers to a time/frequency resource, such as a resource element (RE), resource block (RB), physical resource block (PRB), or OFDM symbol. Particularly, in some embodiments, the wireless device 200 is configured to perform (optional) step S108: S108: The wireless device 200 sends a request to the access network node 300 for the wireless device 200 to send the CSI reporting to the access network node 300. According to an example, the wireless device 200 might send a scheduling request in a physical uplink control channel (PUCCH) message to inform the access network node 300 that the wireless device 200 intends to send CSI reporting when at least one of the event conditions for CSI reporting is fulfilled. In some embodiments, the request is thus sent in a PUCCH message. In this way, one bit in the PUCCH message could be dedicated for the wireless device 200 to request resources for sending the CSI reporting. The request could also be sent in a physical uplink shared channel (PUSCH) message.

The access network node 300 might then respond with a grant for the resources. Particularly, in some embodiments, the wireless device 200 is configured to perform (optional) step S110: Silo: The wireless device 200 receives a grant from the access network node 300 for the wireless device 200 to send the CSI.

In some embodiments, the grant is received in a physical downlink control channel (PDCCH) message.

In other aspect, the wireless device 200 utilizes already granted resource for sending the CSI reporting. That is, the CSI reporting might be sent without being preceded by any dedicated scheduling request.

Aspects of reporting configurations will now be disclosed.

In some aspects, the CSI reporting is provided in a medium access control (MAC) control element (CE). That is, in some embodiments, in accordance with the reporting configuration, the CSI reporting is sent in a MAC CE. In other embodiments, in accordance with the reporting configuration, the CSI reporting is sent in a PUCCH message. In yet further embodiments, in accordance with the reporting configuration, the CSI reporting is sent in a PUSCH message.

In some aspects, the CSI reporting is sent as long as at least one event condition is fulfilled. In particular, in some embodiments, the CSI reporting is sent to the access network node 300 as the protocol layer 2 CSI report and in accordance with the reporting configuration as long as at least one of the event conditions for the CSI reporting is fulfilled.

There could be different examples of event conditions. In general terms, the event conditions could be the same as those used for CSI reporting on protocol layer 3 (but excluding carrier aggregation and inter-RAT related events). In some non-limiting examples, the event conditions, when FDD is used, pertain to at least one of: Event 1: A non-serving TRP enters Reporting Range, Event 2: A serving TRP leaves Reporting Range, Event 3: A non-serving TRP leaves Reporting Range, Event 4: A non-serving TRP becomes better than a serving TRP, Event 5: Change of best serving TRP, Event 6: A serving TRP becomes worse than an absolute threshold, Event 7: A serving TRP becomes better than an absolute threshold.

In further examples, the CSI values are compared to the event conditions in terms of any of: RSRP, reference signal received quality (RSRQ), signal to interference plus noise ratio (SINR), CQI, power headroom report (PHR), RI, reference signal time difference (RSTD.

Aspects relating to possible actions that might be performed after the wireless device 200 has sent the CSI reporting in step S112 will be disclosed next. According to an embodiment, the wireless device 200 is configured to perform (optional) step S114 upon having sent the CSI reporting in step S112.

S114: The wireless device 200 receives a TRP usage command from the access network node 300 in response to having sent the CSI reporting.

Examples of TRP usage commands will be disclosed below. Upon having received the TRP usage command the wireless device 200 then performs the corresponding TRP usage action. That is, in some embodiments, the wireless device 200 is configured to perform (optional) step S116 upon having received the TRP usage command.

S116: The wireless device 200 performs a TRP usage action in accordance with the TRP usage command.

There could be different examples of TRP usage commands and thus of corresponding TRP usage actions. Non-limiting examples of TRP usage action, for a given TRP usage command, will be listed next. According to a first example, when the TRP usage command pertains to changing the serving beam, performing the TRP usage action involves the wireless device 200 to change the serving beam. Further, changing the serving beam implies that the wireless device 200 is released from being served by the current serving beam. This implies that the wireless device 200 is continued to be served by the access network node 300 in another beam, such as in one of the candidate beams. The thus new serving beam might be generated at the same TRP 140, 140a, 140b as the current serving beam or at another TRP 140, 140a, 140b of the same access network node 300. Further, the wireless device 200 might be served in parallel in two or more beams and changing the serving beam thus implies that at least one of these beams is changed. According to a second example, when the TRP usage command pertains to switching radio access technology, performing the TRP usage action involves the wireless device 200 to change radio access technology.

According to a third example, when the TRP usage command pertains to changing bandwidth part, performing the TRP usage action involves the wireless device 200 to change the bandwidth part. According to a fourth example, when the TRP usage command pertains to changing rank, performing the TRP usage action involves the wireless device 200 to change the rank.

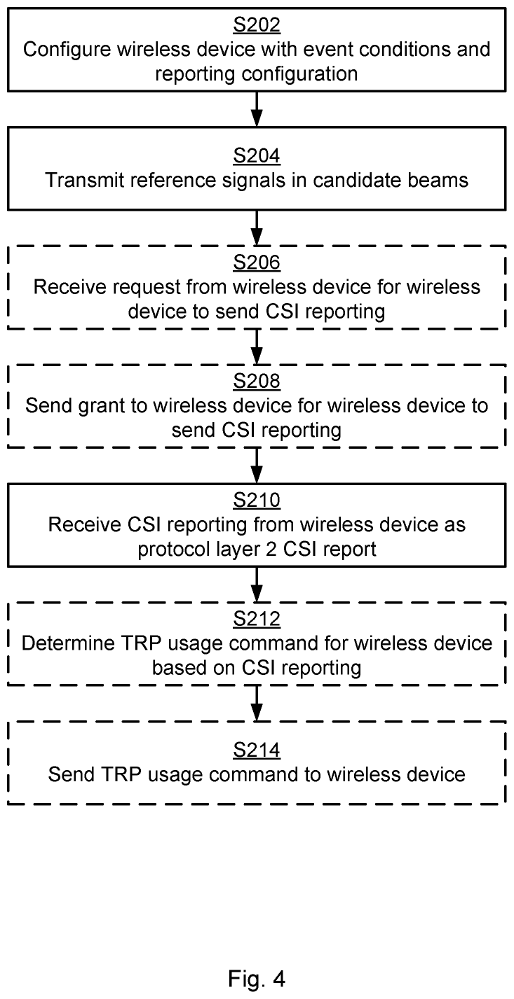

Reference is now made to FIG. 4 illustrating a method for receiving CSI reporting on protocol layer 2 as performed by the access network node 300 according to an embodiment. The access network node 300 serves a wireless device 200 on a serving beam.

S202: The access network node 300 configures the wireless device 200 with event conditions as to when the wireless device 200 is to provide the CSI reporting to the access network node 300 and with reporting configuration as to how the wireless device 200 is to provide the CSI reporting to the access network node 300.

S204: The access network node 300 transmits reference signals in candidate beams.

The reference signals are intended to be received by the wireless device 200. As disclosed above, the wireless device 200 monitors the candidate beams and sends CSI reporting to the access network node 300 as a protocol layer 2 CSI report and in accordance with the reporting configuration.

S210: The access network node 300 receives the CSI reporting from the wireless device 200 as a protocol layer 2 CSI report and in accordance with the reporting configuration.

Embodiments relating to further details of receiving CSI reporting on protocol layer 2 as performed by the access network node 300 will now be disclosed.

In general terms, all embodiments, aspects, and examples as disclosed above with reference to the methods performed by the wireless device 200 are also applicable to the methods performed by the access network node 300.

As disclosed above, in some aspects, the wireless device 200, before sending the CSI reporting, requests the access network node 300 to grant the wireless device 200 resources to send the CSI reporting. Particularly, in some embodiments, the access network node 300 is configured to perform (optional) step S206: S206: The access network node 300 receives a request from the wireless device 200 for the wireless device 200 to send the CSI reporting to the access network node 300.

The access network node 300 might then respond with a grant for the resources.

Particularly, in some embodiments, the access network node 300 is configured to perform (optional) step S208: S208: The access network node 300 sends a grant to the wireless device 200 for the wireless device 200 to send the CSI reporting to the access network node 300.

As disclosed above, in some aspects, possible actions might be performed after the wireless device 200 has sent the CSI reporting in step S112, and thus after the access network node 300 has received the CSI reporting from the wireless device 200 in step S210. Particularly, in some embodiments, the access network node 300 is configured to perform (optional) step S212 and step S214 upon having received the CSI reporting from the wireless device 200 in step S210: S212: The access network node 300 determines a TRP usage command for the wireless device 200 based on the CSI reporting.

S214: The access network node 300 sends the TRP usage command to the wireless device 200.

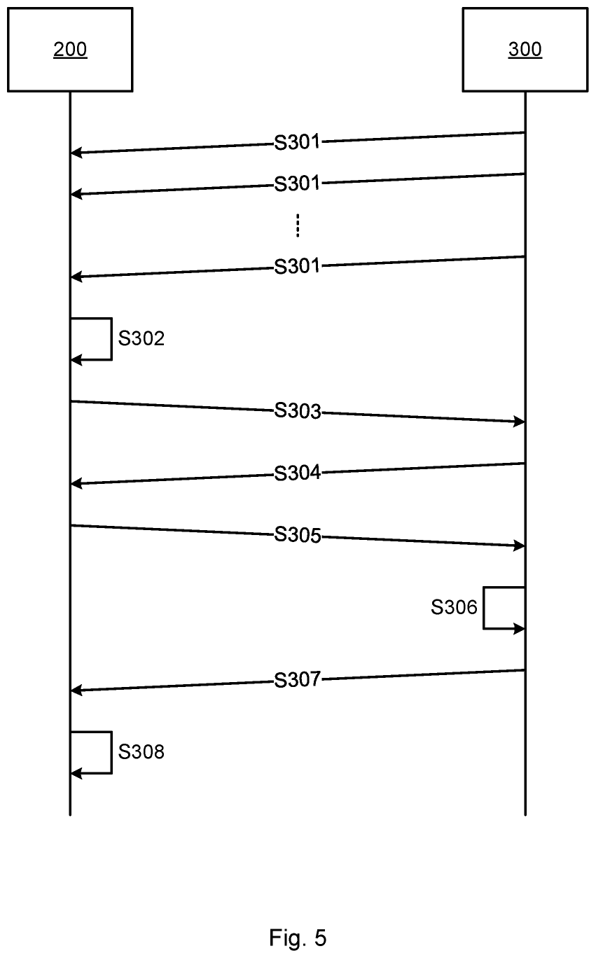

One particular embodiment for CSI reporting on protocol layer 2 based on at least some of the above disclosed embodiments will now be disclosed in detail with reference to the signalling diagram of FIG. 5. It is assumed that the wireless device 200 is served by an access network node 300 on a serving beam. The wireless device 200 is configured with event conditions as to when to provide the CSI reporting to the access network node 300 and with reporting configuration as to how to provide the CSI reporting to the access network node 300.

S301: The access network node 300 transmits reference signals in candidate beams.

The wireless device 200 obtains CSI values by monitoring candidate beams in which reference signals are transmitted by the access network node 300. In general terms, the reference signals are periodically transmitted in each of the candidate beams.

S302: The wireless device 200, based on comparing the CSI values to the event conditions, determines that at least one of the event conditions for CSI reporting is fulfilled.

S303: The wireless device 200 sends a scheduling request to the access network node 300 for the wireless device 200 to send the CSI reporting to the access network node 300. The access network node 300 receives the scheduling request from the wireless device 200.

S304: The access network node 300 sends a uplink grant to the wireless device 200 for the wireless device 200 to send the CSI reporting to the access network node 300.

The wireless device 200 receives the uplink grant from the access network node 300.

S305: The wireless device 200 sends the CSI reporting to the access network node 300 as a protocol layer 2 CSI report and in accordance with the reporting configuration. The access network node 300 receives the CSI reporting from the wireless device 200.

S306: The access network node 300 determines a TRP usage command for the wireless device 200 based on the CSI reporting. As an illustrative example, the access network node 300 determines, based on the CSI reporting, that a beam switch is to be performed and thus the TRP usage command pertains to changing the serving beam.

S307: The access network node 300 sends the TRP usage command to the wireless device 200. The wireless device 200 receives the TRP usage command from the access network node 300.

S308: The wireless device 200 performs a TRP usage action in accordance with the TRP usage command. As an illustrative example, performing the TRP usage action involves the wireless device 200 to change the serving beam when the TRP usage command pertains to changing the serving beam. Transmission and reception for communication between the access network node 300 and the wireless device 200 is then transferred to the new serving beam.

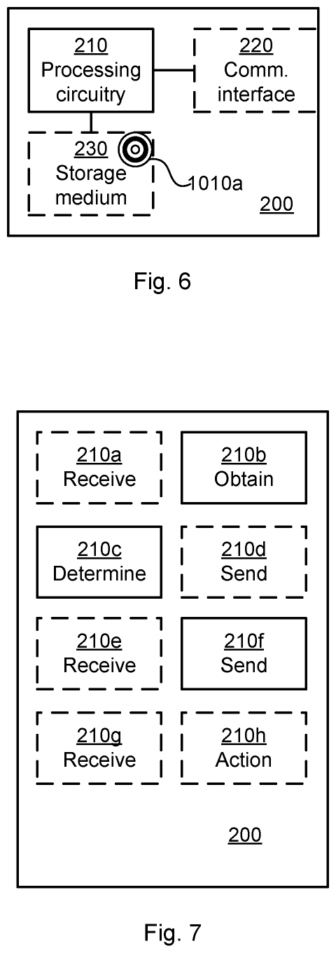

FIG. 6 schematically illustrates, in terms of a number of functional units, the components of a wireless device 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 1010a (as in FIG. 10), e.g. in the form of a storage medium 230. The processing circuitry 210 may further be provided as at least one application specific integrated circuit (ASIC), or field programmable gate array (FPGA).

Particularly, the processing circuitry 210 is configured to cause the wireless device 200 to perform a set of operations, or steps, as disclosed above. For example, the storage medium 230 may store the set of operations, and the processing circuitry 210 may be configured to retrieve the set of operations from the storage medium 230 to cause the wireless device 200 to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The wireless device 200 may further comprise a communications interface 220 for communications at least with the access network node 300. As such the communications interface 220 may comprise one or more transmitters and receivers, comprising analogue and digital components.

The processing circuitry 210 controls the general operation of the wireless device 200 e.g. by sending data and control signals to the communications interface 220 and the storage medium 230, by receiving data and reports from the communications interface 220, and by retrieving data and instructions from the storage medium 230. Other components, as well as the related functionality, of the wireless device 200 are omitted in order not to obscure the concepts presented herein.

FIG. 7 schematically illustrates, in terms of a number of functional modules, the components of a wireless device 200 according to an embodiment. The wireless device 200 of FIG. 7 comprises a number of functional modules; an obtain module 210b configured to perform step S104, a determine module 210c configured to perform step S106, and a send module 210f configured to perform step S112. The wireless device 200 of FIG. 7 may further comprise a number of optional functional modules, such as any of a receive module 210a configured to perform step S102, a send module 210d configured to perform step S108, a receive module 210e configured to perform step S110, a receive module 210g configured to perform step S114, and an action module 210h configured to perform step S116.

In general terms, each functional module 210a:210h may be implemented in hardware or in software. Preferably, one or more or all functional modules 210a:210h may be implemented by the processing circuitry 210, possibly in cooperation with the communications interface 220 and/or the storage medium 230. The processing circuitry 210 may thus be arranged to from the storage medium 230 fetch instructions as provided by a functional module 210a:210h and to execute these instructions, thereby performing any steps of the wireless device 200 as disclosed herein.

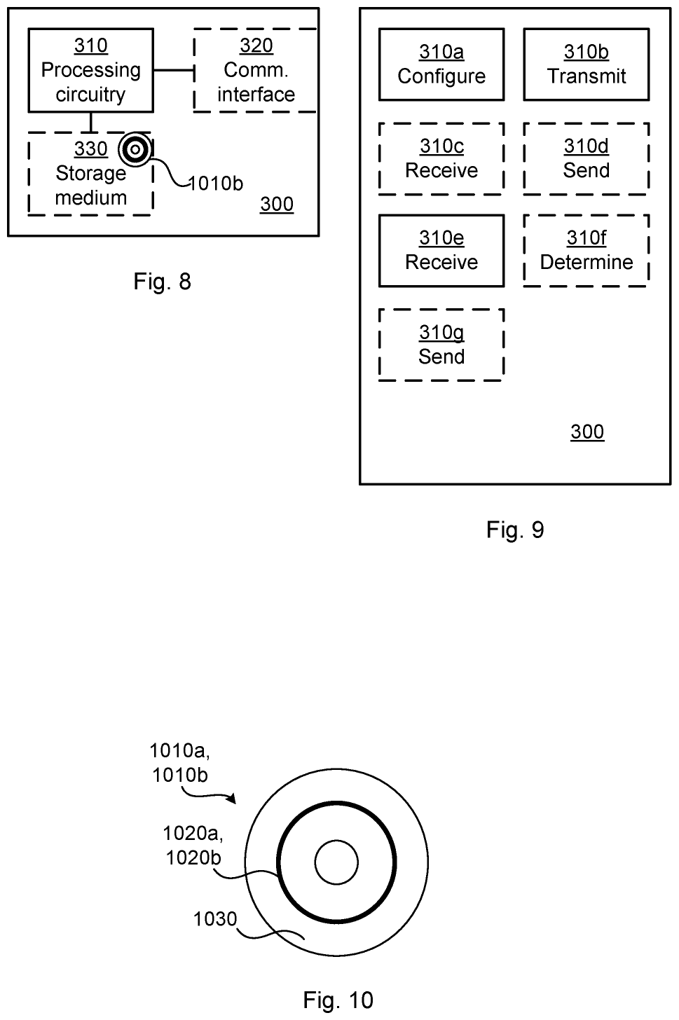

FIG. 8 schematically illustrates, in terms of a number of functional units, the components of an access network node 300 according to an embodiment. Processing circuitry 310 is provided using any combination of one or more of a suitable central processing unit (CPU), multiprocessor, microcontroller, digital signal processor (DSP), etc., capable of executing software instructions stored in a computer program product 1010b (as in FIG. 10), e.g. in the form of a storage medium 330. The processing circuitry 310 may further be provided as at least one application specific integrated circuit (ASIC), or field programmable gate array (FPGA).

Particularly, the processing circuitry 310 is configured to cause the access network node 300 to perform a set of operations, or steps, as disclosed above. For example, the storage medium 330 may store the set of operations, and the processing circuitry 310 may be configured to retrieve the set of operations from the storage medium 330 to cause the access network node 300 to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The access network node 300 may further comprise a communications interface 320 for communications at least with the wireless device 200. As such the communications interface 320 may comprise one or more transmitters and receivers, comprising analogue and digital components.

The processing circuitry 310 controls the general operation of the access network node 300 e.g. by sending data and control signals to the communications interface 320 and the storage medium 330, by receiving data and reports from the communications interface 320, and by retrieving data and instructions from the storage medium 330. Other components, as well as the related functionality, of the access network node 300 are omitted in order not to obscure the concepts presented herein.

FIG. 9 schematically illustrates, in terms of a number of functional modules, the components of an access network node 300 according to an embodiment. The access network node 300 of FIG. 9 comprises a number of functional modules; a configure module 310a configured to perform step S202, a transmit module 310b configured to perform step S204, and a receive module 310e configured to perform step S210. The access network node 300 of FIG. 9 may further comprise a number of optional functional modules, such as any of a receive module 310c configured to perform step S206, a send module 310d configured to perform step S208, a determine module 310f configured to perform step S212, and a send module 310g configured to perform step S214.

In general terms, each functional module 310a:310g may be implemented in hardware or in software. Preferably, one or more or all functional modules 310a:310g may be implemented by the processing circuitry 310, possibly in cooperation with the communications interface 320 and/or the storage medium 330. The processing circuitry 310 may thus be arranged to from the storage medium 330 fetch instructions as provided by a functional module 310a:310g and to execute these instructions, thereby performing any steps of the access network node 300 as disclosed herein.

The access network node 300 may be provided as a standalone device or as a part of at least one further device. Thus, a first portion of the instructions performed by the access network node 300 may be executed in a first device, and a second portion of the instructions performed by the access network node 300 may be executed in a second device; the herein disclosed embodiments are not limited to any particular number of devices on which the instructions performed by the access network node 300 may be executed. Hence, the methods according to the herein disclosed embodiments are suitable to be performed by an access network node 300 residing in a cloud computational environment. Therefore, although a single processing circuitry 310 is illustrated in FIG. 8 the processing circuitry 310 may be distributed among a plurality of devices, or nodes. The same applies to the functional modules 310a:310g of FIG. 9 and the computer program 1020b of FIG. 10.

FIG. 10 shows one example of a computer program product 1010a, 1010b comprising computer readable means 1030. On this computer readable means 1030, a computer program 1020a can be stored, which computer program 1020a can cause the processing circuitry 210 and thereto operatively coupled entities and devices, such as the communications interface 220 and the storage medium 230, to execute methods according to embodiments described herein. The computer program 1020a and/or computer program product 1010a may thus provide means for performing any steps of the wireless device 200 as herein disclosed. On this computer readable means 1030, a computer program 1020b can be stored, which computer program 1020b can cause the processing circuitry 310 and thereto operatively coupled entities and devices, such as the communications interface 320 and the storage medium 330, to execute methods according to embodiments described herein. The computer program 1020b and/or computer program product 1010b may thus provide means for performing any steps of the access network node 300 as herein disclosed. In the example of FIG. 10, the computer program product 1010a, 1010b is illustrated as an optical disc, such as a CD (compact disc) or a DVD (digital versatile disc) or a Blu-Ray disc. The computer program product 1010a, 1010b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1020a, 1020b is here schematically shown as a track on the depicted optical disk, the computer program 1020a, 1020b can be stored in any way which is suitable for the computer program product 1010a, 101b.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for CSI reporting on protocol layer 2, the method being performed by a wireless device, wherein the wireless device is served by an access network node on a serving beam, and wherein the wireless device is configured with event conditions as to when to provide the CSI reporting to the access network node and with reporting configuration as to how to provide the CSI reporting to the access network node, the method comprising:
obtaining CSI values by monitoring candidate beams in which reference signals are transmitted by the access network node;
determining, based on comparing the CSI values to the event conditions, that at least one of the event conditions for CSI reporting is fulfilled; and
sending the CSI reporting to the access network node as a protocol layer 2 CSI report and in accordance with the reporting configuration.

2. The method according to claim 1, wherein the method further comprises:
receiving the event conditions and the reporting configuration from the access network node.

3. The method according to claim 1, wherein the CSI values are obtained by measuring received power on the reference signals as received by the wireless device.

4.-7. (canceled)

8. The method according to claim 1, wherein, in accordance with the reporting configuration, the CSI reporting is sent in a PUSCH message.

9. The method according to claim 1, wherein the CSI reporting is sent to the access network node as the protocol layer 2 CSI report and in accordance with the reporting configuration as long as at least one of the event conditions for the CSI reporting is fulfilled.

10. The method according to claim 1, wherein the method further comprises:
receiving a TRP usage command from the access network node in response to having sent the CSI reporting; and
performing a TRP usage action in accordance with the TRP usage command.

11. The method according to claim 10, wherein when the TRP usage command pertains to changing the serving beam, performing the TRP usage action involves the wireless device to change the serving beam, wherein when the TRP usage command pertains to switching radio access technology, performing the TRP usage action involves the wireless device to change radio access technology, wherein when the TRP usage command pertains to changing bandwidth part, performing the TRP usage action involves the wireless device to change the bandwidth part, and wherein when the TRP usage command pertains to changing rank, performing the TRP usage action involves the wireless device to change the rank.

12. The method according to claim 1, wherein the event conditions, when FDD is used, pertain to at least one of Event 1 to Event 7 defined as follows:
Event 1: A non-serving TRP enters Reporting Range,
Event 2: A serving TRP leaves Reporting Range,
Event 3: A non-serving TRP leaves Reporting Range,
Event 4: A non-serving TRP becomes better than a serving TRP,
Event 5: Change of best serving TRP,
Event 6: A serving TRP becomes worse than an absolute threshold,
Event 7: A serving TRP becomes better than an absolute threshold.

13.-14. (canceled)

15. The method according to claim 1, wherein, in accordance with the reporting configuration, the CSI reporting is sent in a PUCCH message.

16. A method for receiving CSI reporting on protocol layer 2, the method being performed by an access network node, wherein the access network node serves a wireless device on a serving beam, the method comprising:
configuring the wireless device with event conditions as to when the wireless device is to provide the CSI reporting to the access network node and with reporting configuration as to how the wireless device is to provide the CSI reporting to the access network node;
transmitting reference signals in candidate beams; and
receiving the CSI reporting from the wireless device as a protocol layer 2 CSI report and in accordance with the reporting configuration.

17. (canceled)

18. The method according to claim 16, wherein the method further comprises:
determining a TRP usage command for the wireless device based on the CSI reporting; and
sending the TRP usage command to the wireless device.

19. A wireless device for CSI reporting on protocol layer 2, the wireless device being configured to be served by an access network node on a serving beam, wherein the wireless device is configured with event conditions as to when to provide the CSI reporting to the access network node and with reporting configuration as to how to provide the CSI reporting to the access network node, the wireless device comprising processing circuitry, the processing circuitry being configured to cause the wireless device to:
obtain CSI values by monitoring candidate beams in which reference signals are transmitted by the access network node;
determine, based on comparing the CSI values to the event conditions, that at least one of the event conditions for CSI reporting is fulfilled; and
send the CSI reporting to the access network node as a protocol layer 2 CSI report and in accordance with the reporting configuration.

20. (canceled)

21. The wireless device according to claim 19, wherein the processing circuitry is further configured to cause the wireless device to receive the event conditions and the reporting configuration from the access network node.

22. An access network node for receiving CSI reporting on protocol layer 2, the access network node being configured to serve a wireless device on a serving beam, the access network node comprising processing circuitry the processing circuitry being configured to cause the access network node to:
configure the wireless device with event conditions as to when the wireless device is to provide the CSI reporting to the access network node and with reporting configuration as to how the wireless device is to provide the CSI reporting to the access network node
transmit reference signals in candidate beams; and
receive the CSI reporting from the wireless device as a protocol layer 2 CSI report and in accordance with the reporting configuration.

23. (canceled)

24. The access network node according to claim 22, wherein the processing circuitry is further configured to cause the access network node to:
determine a TRP usage command for the wireless device based on the CSI reporting; and
send the TRP usage command to the wireless device.

25. A computer program for CSI reporting on protocol layer 2, the computer program comprising computer code which, when run on processing circuitry of a wireless device, the wireless device being configured to be served by an access network node on a serving beam, wherein the wireless device is configured with event conditions as to when to provide the CSI reporting to the access network node and with reporting configuration as to how to provide the CSI reporting to the access network node, causes the wireless device to:
obtain CSI values by monitoring candidate beams in which reference signals are transmitted by the access network node;
determine, based on comparing the CSI values to the event conditions, that at least one of the event conditions for CSI reporting is fulfilled; and
send the CSI reporting to the access network node as a protocol layer 2 CSI report and in accordance with the reporting configuration.

26. A computer program for receiving CSI reporting on protocol layer 2, the computer program comprising computer code which, when run on processing circuitry of an access network node the access network node being configured to serve a wireless device on a serving beam, causes the access network node to:
configure the wireless device with event conditions as to when the wireless device is to provide the CSI reporting to the access network node and with reporting configuration as to how the wireless device is to provide the CSI reporting to the access network node;
transmit reference signals in candidate beams; and
receive the CSI reporting from the wireless device as a protocol layer 2 CSI report and in accordance with the reporting configuration.

27. A computer program product comprising a computer program according to claim 25, and a computer readable storage medium on which the computer program is stored.
